(19) United States
(12) Patent Application Publication
(10) Pub. No.: US 2023/0406710 A1
(43) Pub. Date: Dec. 21, 2023

(54) SYSTEM AND METHOD FOR LOW-COST PRODUCTION OF EXPANDED GRAPHITE

(71) Applicant: LOG 9 MATERIALS SCIENTIFIC PRIVATE LIMITED, Bangalore (IN)

(72) Inventors: ANSHUL KUMAR SHARMA, Bangalore (IN); Syed Shajar Ali IMAM, Dibrugarh (IN)

(21) Appl. No.: 18/339,074

(22) Filed: Jun. 21, 2023

(30) Foreign Application Priority Data
Jun. 21, 2022 (IN) 202241035620

(51) Int. Cl. C01B 32/225

(52) U.S. Cl. CPC C01B 32/225

(57) ABSTRACT

The embodiments herein provide a low-cost, highly scalable, and automated system for the expansion of intercalated graphite compounds for the production of expanded graphite. The embodiments herein also provide an automated system (100) and method (200) for the synthesis and production of expanded graphite using a gas-based heating system. The system (100) comprises a housing (101) defining a production chamber (101a) having an open side (101b). A retractable tray (104) is movable into the production chamber through the open side, and the retractable tray comprises a holder (105) to hold a removable vessel (106) that contains a graphite intercalation compound. The housing (101) is provided with an opening (102) in a wall to removably receive a gas-based flame generation device (108) into the production chamber, and an exhaust outlet (103) to remove exhaust gases from the production chamber (101a).

### CROSS-REFERENCE TO RELATED APPLICATIONS

This application claims priority to and the benefit of the Provisional Patent Application with serial number IN 202241035620, and title “A SYSTEM AND A METHOD FOR LOW-COST PRODUCTION OF EXPANDED GRAPHITE”, filed in the Indian Patent Office on Jun. 21, 2022, the contents of which is included in its entirety as reference herein.

### BACKGROUND

### Technical Field

The embodiments herein are generally related to the field of material science. The embodiments herein are particularly related to a system and method for a highly scalable and low-cost method of continuous production for expanded graphite. The embodiments herein are more particularly related to an automated production system and method for the production of expanded graphite.

### Description of the Related Art

Graphite consists of a layered hexagonal arrangement of carbon atoms. These carbon atoms have strong bonding within the layers and have weak covalent bonding across the layers. The natural flake graphite is treated with different chemical reagents to form graphite intercalation compounds (GICs). These chemical reagents are called intercalants which when treated with natural flake graphite intercalate in between the layers of the graphite structure. Upon exposure to sufficient heating, these GICs expand along the c-axis forming expanded intercalated graphite compounds (commonly known as expanded graphite), which have a highly porous worm-like structure with a volumetric expansion ratio in the range of 100-800.

Expanded graphite is widely used in several applications because of its excellent physical and chemical properties. For example, expanded graphite is used to make flexible graphitic compounds which are used as one of the best mechanical sealing materials in industries. Further, expanded graphite is used in the recovery of oil from water because of its excellent absorption capacity and oleophilic properties. Surface functionalized expanded graphite is also used for treating wastewater in the water treatment plants for removing heavy metals and harmful chemicals. It is also used as an excellent air filter material for removing ozone, VOCs, NOx, and SOx gases. Thin sheets of expanded graphite have excellent thermal conductivity and are used in heat spreaders and thermal management systems. Expanded graphite is also a great fire-retardant material that finds applications in high-temperature and fire-resilient working conditions.

Expanded graphite is typically manufactured by heating a GIC through microwave heating or furnace heating processes. These heating processes generally include highly labor-intensive systems and highly energy-consuming production methods.

Hence there is a need for a low-cost and highly scalable automated system and method thereof for manufacturing expanded graphite.

The above-mentioned shortcomings, disadvantages and problems are addressed herein, and which will be understood by reading and studying the following specification.

### OBJECTIVES OF THE EMBODIMENTS HEREIN

The primary object of the embodiments herein is to provide a low-cost, highly scalable system, and automated method for manufacturing the expanded intercalated graphite compounds.

Another object of the embodiments herein is to provide a system that eliminates the use of high energy-consuming production methods and provides a very simple approach for the expansion of GICs.

Yet another object of the embodiments herein is to provide an automated system for the synthesis and production of graphite intercalation compounds (GICs).

These and other objects and advantages herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide a low-cost, highly scalable, and automated system for the expansion of intercalated graphite compounds to produce expanded graphite intercalation compounds (i.e., expanded graphite). The embodiments herein also provide a system that eliminates the use of high energy-consuming production methods and provides a very simple approach for the expansion of GICs. The embodiments herein also provide an automated system for the synthesis and production of expanded graphite using a gas-based heating system.

According to one embodiment herein, a system for the production of expanded graphite is provided. The system comprises a housing defining a production chamber having an open side. The housing is provided with an opening in a wall of the housing to removably receive a gas-based flame generation device into the production chamber and an exhaust outlet to remove exhaust gases from the production chamber. A retractable tray is moved into the production chamber through the open side, and the retractable tray comprises a holder to hold a removable vessel that contains a graphite intercalation compound (GIC). When the GIC is heated by a gas-based flame generation device, expanded graphite is produced.

According to an embodiment herein, a method for producing expanded graphite is provided. The method comprising the steps of maintaining a humidity level in a production chamber defined by a housing; disposing an amount of a graphite intercalation compound in a removable vessel hold on to a tray by a holder, wherein the tray is retractable into the production chamber; moving the retractable tray with the removable vessel containing the graphite intercalation compound into the production chamber; generating a flame from a gas-based flame generation device that is received in the production chamber through an opening in a wall of the housing; and exposing the graphite intercalation compound contained in the removable vessel to the flame generated from the gas-based flame generation device to generate the expanded graphite.

According to an embodiment herein, the gas-based flame generation device is coupled to a heating system.

According to an embodiment herein, the heating system comprises a gas source, a first gas regulator coupled to the gas source, and a second gas regulator coupled to the gas-based flame generation device. The gas source comprises a working gas selected from a group consisting of natural gas, petroleum gas, or a combination thereof. The working gas is selected from a group consisting of Methane, Ethane, Propane, Butane, Acetylene, Butylene, Ethylene, Hydrogen, Propylene, Coal gas, blue water gas, Oxy-acetylene or CNG or a combination thereof. According to an embodiment, the working gas comprises propane, butane, butylene, and propylene.

According to an embodiment herein, the retractable tray comprises an automated vessel rotator coupled to the holder to rotate the removable vessel about a longitudinal axis of the vessel.

According to an embodiment herein, a flipper is coupled to the retractable tray to rotate the tray about a longitudinal axis of the retractable tray.

According to an embodiment herein, the production chamber is maintained at a humidity level of 0.1% to 50%.

According to an embodiment herein, the automated vessel rotator is configured to rotate the vessel in a range of 1 RPM to 100 RPM.

According to an embodiment herein, the gas-based flame generation device is configured to generate a flame at a temperature in a range of from 1500 degree Celsius to 3500 degree Celsius.

According to an embodiment herein, the system further comprises a removable storage tank installed below the production chamber to collect the expanded graphite from the removable vessel held on the retractable tray.

According to an embodiment herein, the system, the heating system includes a gas source, regulators, valve, etc. The heating system comprises a first gas regulator configured to regulate the flow rate of gas supplied from the gas source (e.g., a cylinder) and a second gas regulator configured to control a supply of gas to the gas-based flame generation device to generate the flame.

According to an embodiment herein, the method comprises preparing the graphite intercalation compound using a starting material and an intercalation agent, wherein the starting material comprises natural flake graphite, synthetic graphite, or a combination thereof, and the intercalation agent and wherein the intercalation agent comprises sulphuric acid, nitric acid, phosphoric acid, potassium permanganate, perchloric acid, or combinations thereof.

According to an embodiment herein, the step of maintaining the humidity level comprises maintaining the humidity level in a range of from 0.1% to 50%.

According to an embodiment herein, the step of exposing the graphite intercalation compound comprises rotating the removable vessel containing the graphite intercalation compound about a longitudinal axis of the removable vessel using an automated vessel rotator coupled to the holder.

According to an embodiment herein, the step of exposing the graphite intercalation compound further comprises tilting the retractable tray about a longitudinal axis of the retractable tray.

According to an embodiment herein, the step of exposing the graphite intercalation compound further comprises rotating the vessel with a speed in a range of 1 RPM to 100 RPM.

According to an embodiment herein, the step of exposing the graphite intercalation compound comprises maintaining the flame generated from the gas-based flame generation device at a temperature in a range of from 1500 degree Celsius to 3500 degree Celsius.

According to an embodiment herein, the step of generating the flame comprises providing a flow of working gas from a gas source of a heating system to the gas-based flame generation device.

According to an embodiment herein, the step of generating the flame comprises regulating the flow of gas from the gas source to the gas-based flame generation device.

According to an embodiment herein, the working gas comprises natural gas or petroleum gas.

According to an embodiment herein, the working gas is selected from a group consisting of Methane, Ethane, Propane, Butane, Acetylene, Butylene, Ethylene, Hydrogen, Propylene, Coal gas, blue water gas, Oxy-acetylene or CNG, and a combination thereof.

According to an embodiment herein, the further comprises allowing an exhaust gas to be removed from the production chamber.

According to one embodiment herein, the retractable tray with the removable vessel is configured to be moved in forward/backward directions and tilted about its longitudinal axis.

According to one embodiment herein, the starting material loaded into the production chamber includes natural flake graphite and synthetic graphite.

According to one embodiment herein, the intercalation agents include sulphuric acid H₂SO₄, nitric acid HNO₃, phosphoric acid H₃PO₄, potassium permanganate KMnO₄, and perchloric acid HClO₄, such that the starting material and intercalation agent react together to form a slurry of graphite intercalation compound. The size of the graphite intercalation compound (or slurry) is in the range of mesh size +3 to +400.

According to one embodiment herein, the humidity levels are maintained in the production chamber in the range of 0.1% to 50% by the humidity sensor. Humidity levels greater than 50% reduce the efficiency of the expansion of the GICs, whereas a controlled humidity level within the range of 0.1% to 50% provides high throughput.

According to one embodiment herein, the system also comprises an exhaust outlet for the removal of exhaust gases from the production chamber. The exhaust gases are purified by an air purifier, comprising a graphene ceramic composite filter (GCC), or an activated carbon filter and a scrubber unit for further purification. The filtered particles are preferably in granular form, and in size ranging from 100 μm-1000 μm, more preferably in the range of 100 μm-200 μm, 200 μm-400 μm, 400 μm-600 μm, 600 μm-800 μm or 800 μm-1000 um.

According to one embodiment herein, the automated vessel rotator coupled to the holder, is configured to rotate the removable vessel containing graphite intercalation compound in a clockwise and/or anti-clockwise directions to expose most of or all the graphite intercalation compound to the flame generated by a gas-based flame generation device, and to increase the efficiency of production of expanded graphite. Furthermore, the automated vessel rotator is configured to rotate the removable vessel containing graphite intercalation compound at a speed in a range of 1 RPM to 100 RPM.

According to one embodiment herein, the gas-based flame generation device, arranged in the production chamber, is configured to maintain the temperature or heat needed for the production of expanded graphite from the graphite intercalation compound. The temperature required to be maintained by the gas-based flame generation device for the production of expanded graphite is in the range of 1500° C. to 3500° C. The gas-based flame generation device comprises a removable flame torch comprising an auto-ignition system for lighting the removable flame torch.

According to one embodiment herein the heating system further comprises a gas source (such as a gas storage tank), a first gas regulator to control the supply of the gas, a second gas regulator, configured to regulate the gas flow rate required for the expansion process, a pressure gauge regulators, configured to maintain pressure across the gas-based flame generation device.

According to one embodiment herein, the removable flame torch is further connected with a flexible pipe, for the ease of movement of the removable flame torch inside the production chamber. Further, the flexible pipe is provided with a gas valve, connected to a fixed metal-based gas pipeline, and is configured to regulate the supply of gas individually to each of the gas-based flame generation devices. In addition, the fixed metal-based gas pipeline also comprises a safety valve connected to the gas storage tank, which is configured to cut off the gas supply in case of emergency. Furthermore, the removable flame torch comprises a nozzle having a diameter in the range of 1 mm to 5 cm, and more preferably 1 mm-5 mm, 5 mm-1 cm, 1 cm-2 cm, 2 cm-3 cm, 3 cm-4 cm or 4 cm-5 cm.

According to one embodiment herein, the heating system utilizes a working gas as an energy source to heat up the graphite intercalation compound or intercalated compounds to produce expanded graphite. The working gas is selected from the group consisting of natural gas or petroleum gas, and preferably the working gas is selected from a combination of Methane, Ethane, Propane, Butane, Acetylene, Butylene, Ethylene, Hydrogen, Propylene, Coal gas, blue water gas, Oxy-acetylene or CNG. Furthermore, the flow rate of the working gas in the plurality of flame generation channels is in the range of 1 mL/hour −5 L/hour, and more preferably the flow rate of the working gas is 1 mL/hr-100 ml/hour, 100 ml/hr-250 ml/hour, 250 ml/hr-500 ml/hour, 500 ml/hr-1 L/hour, 1 L/hr-2 L/hour, 2 L/hr-3 L/hour, 3 L/hr-4 L/hour or 4 L/hr-5 L/hour. In addition, the pressure maintained by the pressure gauge regulators is in the range of 2.5 kPa to 4 kPa.

According to one embodiment herein, the system is provided with an automated conveyor system that moves the retractable tray and is made from chemical-resistant metals of the stainless-steel group including SS304 and/or SS316. The chemical-resistant metal of the stainless-steel group is coated with an acid-resistant coating made from materials of different grades of Teflon including polytetrafluoroethylene (PTFE) and/or ethylene tetrafluoroethylene (ETFE).

According to one embodiment herein, the removable storage tank is made up of stainless-steel material including SS304 and/or SS316 and the thickness of the stainless-steel material is in the range of 1 mm to 3 mm.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1A illustrates a schematic block diagram of an automated system for the expansion of graphite intercalation compounds (GICs) and thereby producing expanded graphite, according to one embodiment herein.

FIG. 1B illustrates a mechanism for the movement of the retractable tray, according to one embodiment herein.

FIG. 1C illustrates an exemplary model of the automated system for the expansion of graphite intercalation compounds (GICs), according to one embodiment herein.

FIG. 1D illustrates the block diagram of an automated system for the expansion of graphite intercalation compounds (GICs) to produce expanded graphite with removable storage tanks to collect the expanded graphite, according to one embodiment herein.

FIG. 2 illustrates a flowchart explaining a method for the production of expanded graphite, according to one embodiment herein.

FIG. 3 illustrates a photograph of a non-expanded form of graphite compound before processing in the production system, according to one embodiment herein.

FIG. 4 illustrates a photograph of expanded graphite compounds after processing in the production system, according to one embodiment herein.

Although the specific features herein are shown in some drawings and not in others. This is done for convenience only as each feature may be combined with any or all of the other features herein.

### DETAILED DESCRIPTION OF THE EMBODIMENTS HEREIN

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The various embodiments herein, provide a low-cost, highly scalable, and automated system for the expansion of intercalated graphite compounds to produce expanded graphite intercalation compounds (i.e., expanded graphite). The embodiments herein also provide a system that eliminates the use of high energy-consuming production methods and provides a very simple approach for the expansion of GICs. The embodiments herein also provide an automated system for the synthesis and production of expanded graphite using a gas-based heating system.

According to one embodiment herein, a system for the production of expanded graphite is provided. The system comprises a housing defining a production chamber having an open side. The housing is provided with an opening in a wall of the housing to removably receive a gas-based flame generation device into the production chamber, and an exhaust outlet to remove exhaust gases from the production chamber. A retractable tray is moved or slid into the production chamber through the open side, and the retractable tray comprises a holder to hold a removable vessel that contains a graphite intercalation compound (GIC). When the GIC is heated by a gas-based flame generation device, expanded graphite is produced.

The removable vessel is so called as it can be removed from the retractable tray and placed again on the retractable tray. The holder helps to hold the vessel onto the retractable tray. The vessel is a pot or bowl of any shape and suitable size to contain GIC for the expansion process. The vessel is made of a material that sustainable at high temperatures (e.g., up to 3,500° C.). According to an embodiment, the vessel is made of a ceramic material.

According to an embodiment herein, the gas-based flame generation device is coupled to a heating system.

According to an embodiment herein, the heating system comprises a gas source, a first gas regulator coupled to the gas source, and a second gas regulator coupled to the gas-based flame generation device. The gas source comprises a working gas selected from a group consisting of natural gas, petroleum gas or a combination thereof. The working gas is selected from a group consisting of Methane, Ethane, Propane, Butane, Acetylene, Butylene, Ethylene, Hydrogen, Propylene, Coal gas, blue water gas, Oxy-acetylene or CNG or a combination thereof.

According to an embodiment herein, the retractable tray comprises an automated vessel rotator coupled to the holder to rotate the removable vessel about a longitudinal axis of the vessel.

According to an embodiment herein, a flipper is coupled to the retractable tray to rotate the tray about a longitudinal axis of the retractable tray.

According to an embodiment herein, the production chamber is maintained at a humidity level of 0.1% to 50%.

According to an embodiment herein, the automated vessel rotator is configured to rotate the vessel in a range of 1 RPM to 100 RPM.

According to an embodiment herein, the gas-based flame generation device is configured to generate a flame at a temperature in a range of from 1500 degree Celsius to 3500 degree Celsius.

According to an embodiment herein, the system further comprises a removable storage tank installed below the production chamber to collect the expanded graphite from the removable vessel held on the retractable tray.

According to an embodiment herein, the system, the heating system includes a gas source, regulators, valve, etc. The heating system comprises a first gas regulator configured to regulate the flow rate of gas supplied from the gas source (such as a gas cylinder) and a second gas regulator configured to control a supply of gas to the gas-based flame generation device to generate the flame.

According to an embodiment herein, a method for producing expanded graphite is provided. The method comprising the steps of maintaining a humidity level in a production chamber defined by a housing; disposing an amount of a graphite intercalation compound in a removable vessel hold on to a tray by a holder, wherein the tray is retractable into the production chamber; moving the retractable tray with the removable vessel containing the graphite intercalation compound into the production chamber; generating a flame from a gas-based flame generation device that is received in the production chamber through an opening in a wall of the housing; and exposing the graphite intercalation compound contained in the removable vessel to the flame generated from the gas-based flame generation device to generate the expanded graphite.

According to an embodiment herein, the method comprises preparing the graphite intercalation compound using a starting material and an intercalation agent, wherein the starting material comprises natural flake graphite, synthetic graphite, or a combination thereof, and the intercalation agent and wherein the intercalation agent comprises sulphuric acid, nitric acid, phosphoric acid, potassium permanganate, perchloric acid, or combinations thereof.

According to an embodiment herein, the step of maintaining the humidity level comprises maintaining the humidity level in a range of from 0.1% to 50%.

According to an embodiment herein, the step of exposing the graphite intercalation compound comprises rotating the removable vessel containing the graphite intercalation compound about a longitudinal axis of the removable vessel using an automated vessel rotator coupled to the holder.

According to an embodiment herein the step of exposing the graphite intercalation compound further comprises tilting the retractable tray about a longitudinal axis of the retractable tray.

According to an embodiment herein, the step of exposing the graphite intercalation compound further comprises rotating the vessel with a speed in a range of 1 RPM to 100 RPM.

According to an embodiment herein, the step of exposing the graphite intercalation compound comprises maintaining the flame generated from the gas-based flame generation device at a temperature in a range of from 1500 degree Celsius to 3500 degree Celsius.

According to an embodiment herein, the step of generating the flame comprises providing a flow of working gas from a gas source of a heating system to the gas-based flame generation device.

According to an embodiment herein, the step of generating the flame comprises regulating the flow of gas from the gas source to the gas-based flame generation device.

According to an embodiment herein, the working gas comprises natural gas or petroleum gas.

According to an embodiment herein, the working gas is selected from a group consisting of Methane, Ethane, Propane, Butane, Acetylene, Butylene, Ethylene, Hydrogen, Propylene, Coal gas, blue water gas, Oxy-acetylene or CNG and a combination thereof.

According to an embodiment herein, the further comprises allowing an exhaust gas to be removed from the production chamber.

According to one embodiment herein, the retractable tray with the removable vessel is configured to be moved in forward/backward directions and tilted or rotated about its longitudinal axis.

According to one embodiment herein, the starting material loaded into the production chamber includes natural flake graphite and synthetic graphite.

According to one embodiment herein, the intercalation agents include sulphuric acid H₂SO₄, nitric acid HNO₃, phosphoric acid H₃PO₄, potassium permanganate KMnO₄, and perchloric acid HClO₄, such that the starting material and intercalation agents react together to form the graphite intercalation compound. The size of the graphite intercalation compound is in the range of mesh size +3 to +400.

According to one embodiment herein, the humidity levels are maintained in the production chamber in the range of 0.1% to 50% by the humidity sensor. Humidity levels greater than 50% reduce the efficiency of the expansion of the GICs, whereas a controlled humidity level within the range of 0.1% to 50% provides high throughput.

According to one embodiment herein, the system also comprises an exhaust outlet for the removal of exhaust gases from the production chamber. The exhaust gases are purified by an air purifier, comprising a graphene ceramic composite filter (GCC), or an activated carbon filter and a scrubber unit for further purification. The filtered particles are preferably in granular form, and in size ranging from 100 μm-1000 μm, more preferably in the range of 100 μm-200 μm, 200 μm-400 μm, 400 μm-600 μm, 600 μm-800 μm or 800 μm-1000 um.

According to one embodiment herein, the automated vessel rotator coupled to the holder, is configured to rotate the removable vessel containing graphite intercalation compound in a clockwise and/or anti-clockwise directions to expose the most of or all the graphite intercalation compound contained in the vessel to the flame generated from the gas-based flame generation device, and to increase the efficiency of production of expanded graphite. Furthermore, the automated vessel rotator is configured to rotate the removable vessel containing graphite intercalation compound at a speed in a range of 1 RPM to 100 RPM.

According to one embodiment herein, the gas-based flame generation device, arranged in the production chamber, is configured to maintain the temperature or flame needed for the production of expanded graphite from the graphite intercalation compound. The temperature required to be maintained by the gas-based flame generation device for the production of expanded graphite is in the range of 1500° C. to 3500° C. The gas-based flame generation device comprises a removable flame torch comprising an auto-ignition system for lighting the removable flame torch.

According to one embodiment herein, the heating system further comprises a gas source (e.g., a gas storage tank), a first gas regulator to supply a gas (e.g., the working gas) from the gas source, a second gas regulator configured to regulate the gas flow rate required for the expansion process, a pressure gauge regulators configured to maintain pressure of the gas flow to the gas-based flame generation device.

According to one embodiment herein, the removable flame torch is further connected with a flexible pipe, for the ease of movement of the removable flame torch inside the production chamber. Further, the flexible pipe is provided with a gas valve, connected to a fixed metal-based gas pipeline, and is configured to regulate the supply of gas individually to each of the gas-based flame generation devices. In addition, the fixed metal-based gas pipeline also comprises a safety valve connected to the gas storage tank, which is configured to cut off the gas supply in case of emergency. Furthermore, the removable flame torch comprises a nozzle having a diameter in the range of 1 mm to 5 cm, and more preferably 1 mm-5 mm, 5 mm-1 cm, 1 cm-2 cm, 2 cm-3 cm, 3 cm-4 cm or 4 cm-5 cm.

According to one embodiment herein, the heating system utilizes a working gas as an energy source to heat up the graphite intercalation compound or intercalated compounds to produce expanded graphite. The working gas is selected from the group consisting of natural gas or petroleum gas, and preferably the working gas is selected from a combination of Methane, Ethane, Propane, Butane, Acetylene, Butylene, Ethylene, Hydrogen, Propylene, Coal gas, blue water gas, Oxy-acetylene or CNG. Furthermore, the flow rate of the working gas in the plurality of flame generation channels is in the range of 1 mL/hour-5 L/hour, and more preferably the flow rate of the working gas is 1 mL/hr-100 ml/hour, 100 ml/hr-250 ml/hour, 250 ml/hr-500 ml/hour, 500 ml/hr-1 L/hour, 1 L/hr-2 L/hour, 2 L/hr-3 L/hour, 3 L/hr-4 L/hour or 4 L/hr-5 L/hour.

According to one embodiment herein, the pressure of the gas flow from the gas source to the gas-based flame generation device is maintained in the range of 2.5 kPa to 4 kPa by the pressure gauge regulators.

According to one embodiment herein, the system is provided with an automated conveyor system that moves the retractable tray and is made from chemical-resistant metals of the stainless-steel (e.g., SS304 and/or SS316). The chemical-resistant metal of the stainless-steel group is coated with an acid-resistant coating made from materials of different grades of Teflon including polytetrafluoroethylene (PTFE) and/or ethylene tetrafluoroethylene (ETFE).

According to one embodiment herein, the removable storage tank is made up of stainless-steel material (e.g., SS304 and/or SS316) and the thickness of the stainless-steel material is in the range of 1 mm to 3 mm.

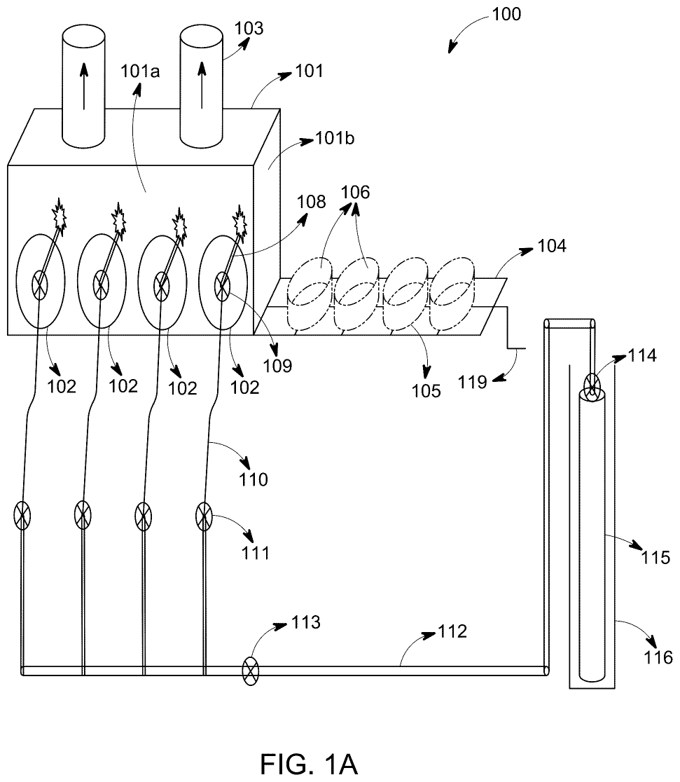

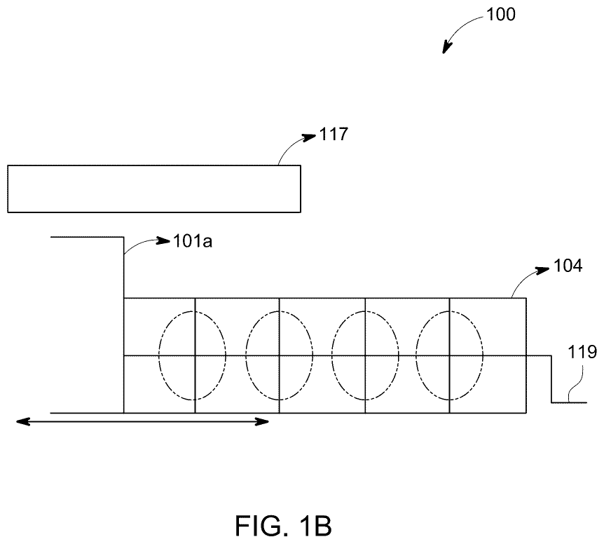

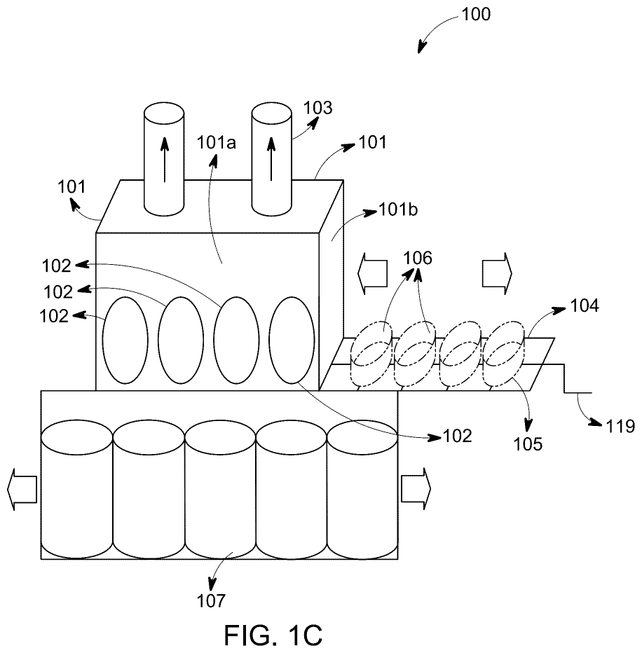

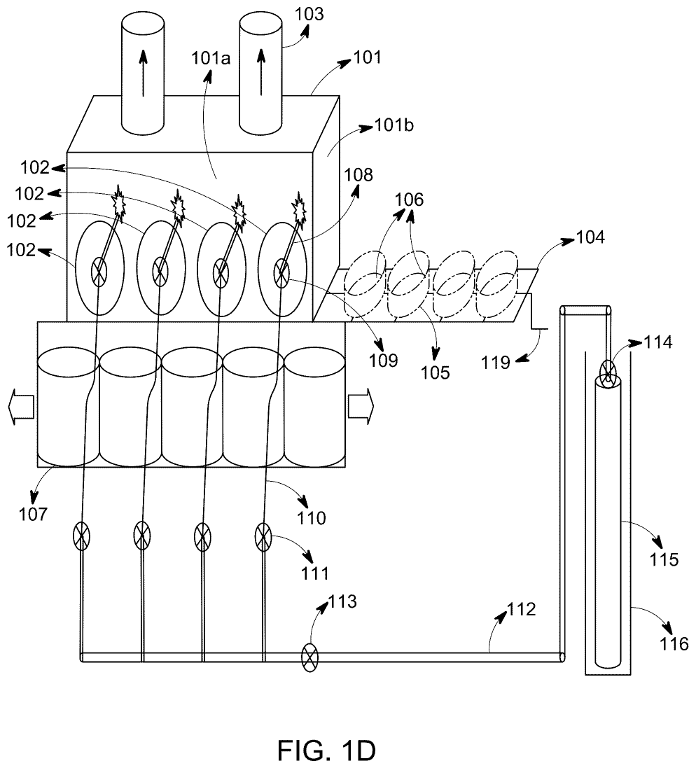

FIG. 1A illustrates a schematic block diagram of an automated system for the expansion of graphite intercalation compounds (GICs) and thereby producing expanded graphite, according to one embodiment herein. In FIG. 1A, system 100 comprises a housing 101 defining a production chamber 101a, having an open side 101b. The housing 101 is provided with an opening 102 in a wall of the housing 101 to removably receive a gas-based flame generation device 108 into the production chamber 101a, and an exhaust outlet 103 to remove exhaust gases from the production chamber 101a. A retractable tray 104 is movable into the production chamber 101a through the open side 101b, and the retractable tray 104 comprises a holder 105 to hold a removable vessel 106 that contains a graphite intercalation compound. The removable vessel 106 is mounted on the retractable tray 104. The housing 101 and the retractable tray 104 may be made of metal to sustain in a high-temperature environment during the expansion process. The movement of the retractable tray 104, while carrying the removable vessel 106, can be moved forward/backward directions and the retractable tray 104 is tilled about its longitudinal axis. In an example, an automated conveyor system (not shown in Figures) helps to move the retractable tray 104 into and out from the production chamber 101a. The retractable tray 104 comprises a holder 105 that holds the removable vessel 106. The removable vessel 106 contains a graphite intercalation compound. The retractable tray 104 comprises an automated vessel rotator (not shown in Figures) coupled to the holder 105 to rotate the removable vessel 106 in the clockwise and/or anticlockwise direction about the longitudinal axis of the removable vessel 106. The production chamber 101a has an opening 102 in a wall of the housing 101 for receiving the gas-based flame generation device 108 into the production chamber 101a. The exhaust outlet 103 helps for the removal of exhaust gases from the production chamber 101a. Furthermore, the gas-based flame generation device 108, arranged in the production chamber 101a, is configured to maintain the temperature or heat needed for the production of expanded graphite from the graphite intercalation compound. The temperature required to be maintained by the gas-based flame generation device 108 for the production of expanded graphite is in the range of 1500° C. to 3500° C. The gas-based flame generation device 108 comprises a removable flame torch comprising an auto-ignition system for lighting the removable flame torch. The gas-based flame generation device 108 is coupled to a heating system comprising a gas source (e.g., a gas storage tank) 115, a first gas regulator 114 to control the supply of the gas from the gas source 115, and a second gas regulator 109, configured to regulate the gas flow rate required for the expansion process. The gas-based flame generation device 108 is further connected with a flexible pipe 110 that connects to the gas source 115 to supply the gas from the gas source 115 to the gas-based flame generation device 108. The flexible pipe 110 provides easy movement of the gas-based flame generation device 108 inside the production chamber 101a.

Further, the flexible pipe 110 is provided with a gas valve 111 connected to a fixed metal-based gas pipeline 112 and is configured to regulate the supply of gas individually to each of the gas-based flame generation devices 108. In addition, the fixed metal-based gas pipeline 112 also comprises a safety valve 113 connected to the gas source 115, which is configured to cut off the gas supply in case of emergency. The gas source 115 may be housed inside a safety enclosure 116 for safety reasons.

FIG. 1B illustrates the mechanism of the movement of the retractable tray, according to one embodiment herein. The retractable tray 104 slides from right to left and vice versa after loading the removable vessel containing the graphite intercalation compound. The retractable tray 104 is made to slide inside and out of production chamber 101a with the help of the automated conveyor system. A flipper 119 coupled to the retractable tray 104 helps to rotate the retractable tray 104 about its longitudinal axis. The flipper 119 helps to tilt the retractable tray 104 and the removable vessel 106 (sown in FIG. 1A). By tilting the retractable tray 104 and the removable vessel 106 (sown in FIG. 1A), the most of or all the graphite intercalation compound is exposed to the flame generated by the gas-based flame generation device thereby increasing the efficiency of the system 100. The flipper 119 also helps in flipping the retractable tray 104 to collect the expanded graphite by inverting the removable vessel 106 (sown in FIG. 1A) into the removable storage tanks 107 (shown in FIG. 1C). The retractable tray 104 is then flipped back to its original position to load the graphite intercalation compound in the removable vessel 106 again.

With respect to FIG. 1C, illustrates an exemplary model of the automated system for the expansion of graphite intercalation compounds (GICs), according to one embodiment herein. In FIG. 1C, system 100 comprises a housing 101 defining a production chamber 101a, having an open side 101b. The housing 101 is provided with an opening 102 in a wall of the housing 101 to removably receive a gas-based flame generation device 108 into the production chamber 101a, and an exhaust outlet 103 to remove exhaust gases from the production chamber 101a. A retractable tray 104 is movable into the production chamber 101a through the open side 101b. The retractable tray 104 comprises a holder 105 that supports the removable vessel 106. The removable vessel 106 contains a graphite intercalation compound. The retractable tray 104 comprises an automated vessel rotator coupled to the holder 105 to rotate the removable vessel 106 in the clockwise and/or anticlockwise direction about the longitudinal axis of the removable vessel 106. The housing 101 and the retractable tray 104 may be made of metal to sustain in a high-temperature environment during the expansion process. The movement of the retractable tray 104 and the removable vessel 106 are controlled by the flipper 119 for forward/backward movement of the retractable tray 104 and the tilting or rotating the retractable tray 104 about its longitudinal axis. The production chamber 101a includes an opening 102 in a wall of the housing 101 to receive the gas-based flame generation device 108 into the production chamber 101a. The production chamber 101a includes the exhaust outlet 103 for the removal of exhaust gases from the production chamber 101a. The production chamber 101a is further provided with the removable storage tank 107 to collect the expanded graphite produced inside the production chamber 101a.

FIG. 1D illustrates the block diagram of an automated system for the expansion of graphite intercalation compounds (GICs) to produce expanded graphite with removable storage tanks to collect the expanded graphite, according to an embodiment herein. In FIG. 1D, system 100 comprises a housing 101 defining a production chamber 101a, having an open side 101b. The housing 101 is provided with an opening 102 in a wall of the housing 101 to removably receive a gas-based flame generation device 108 into the production chamber 101a, and an exhaust outlet 103 to remove exhaust gases from the production chamber 101a. A retractable tray 104 can be moved into the production chamber 101a through the open side 101b. In an example, the retractable tray 104 is moved into the production chamber 101a by sliding. The retractable tray 104 comprises a holder 105 that supports the removable vessel 106. The removable vessel 106 contains a graphite intercalation compound. The retractable tray 104 comprises an automated vessel rotator coupled to the holder 105 to rotate the removable vessel 106 in the clockwise and/or anticlockwise direction about the longitudinal axis of the removable vessel 106. The production chamber 101a includes an opening 102 in a wall of the housing 101 to receive the gas-based flame generation device 108 and the exhaust outlet 103 for the removal of exhaust gases from the production chamber 101a. The system 100 includes removable storage tanks 107 to collect the expanded graphite produced inside the production chamber 101a. FIG. 1D illustrates a plurality of removable storage tanks 107 under the production chamber 101a to collect the expanded graphite, thus produced. The removable storage tank 107 is made up of stainless-steel material including SS304 and/or SS316 and the thickness of the stainless-steel material is in the range of 1 mm to 3 mm. Furthermore, the gas-based flame generation device 108, arranged in the production chamber 101a, is configured to maintain the temperature or heat needed for the production of expanded graphite from the graphite intercalation compound. The temperature required to be maintained by the gas-based flame generation device 108 for the production of expanded graphite is in the range of 1500° C. to 3500° C. The gas-based flame generation device 108 further comprises a removable flame torch comprising an auto-ignition system for lighting the removable flame torch. The gas-based flame generation device 108 is coupled to a heating system comprising a gas source 115, a first gas regulator 114, and a second gas regulator 109. In an instance, the heating system includes the gas-based flame generation device 108. The first gas regulator 114 controls the supply of the gas from the gas source 115 and the second gas regulator 109 regulates or controls the gas flow to the gas-based flame generation device 108. In case of multiple gas-based flame generation devices 108 received into the production chamber 101a, the gas flow of each gas-based flame generation device 108 is regulated or controlled separately by a second gas regulator 109 coupled to each of the gas-based flame generation devices 108.

Moreover, the gas-based flame generation device 108 is further connected with a flexible pipe 110, that connects to the gas source 115 to supply the gas from the gas source 115 to the gas-based flame generation device 108. The flexible pipe 110 provides easy movement of the gas-based flame generation device 108 inside the production chamber 101a. Further, the flexible pipe 110 is provided with a gas valve 111 connected to a fixed metal-based gas pipeline 112 and is configured to regulate the supply of gas individually to each of the gas-based flame generation devices 108. In addition, the fixed metal-based gas pipeline 112 also comprises a safety valve 113 connected to the gas source 115, which is configured to cut off the gas supply in case of emergency. The gas source 115 may be housed inside a safety enclosure 116 for safety reasons.

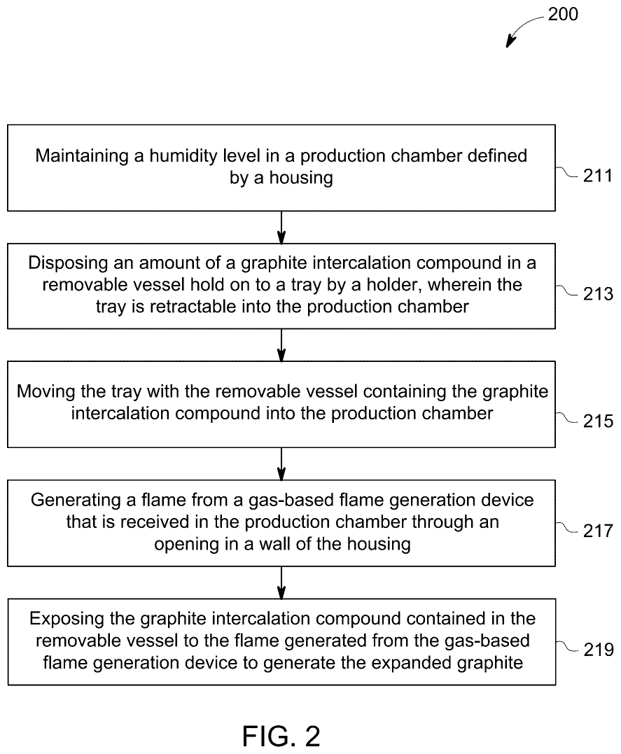

FIG. 2 illustrates a flowchart depicting a method for the production of expanded graphite, according to one embodiment herein. The method 200 includes the steps of maintaining a humidity level in a production chamber defined by a housing at step 211. The method 200 further includes disposing an amount of a graphite intercalation compound in a removable vessel hold on to a tray by a holder, wherein the tray is retractable into the production chamber at step 213 after maintaining the humidity level of the production chamber. Further, the method 200 includes moving the retractable tray with the removable vessel containing the graphite intercalation compound into the production chamber at step 215. The retractable tray is configured to be moved into the production chamber with the help of an automated conveyor system. In addition, the method 200 includes generating a flame from a gas-based flame generation device that is received in the production chamber through an opening in a wall of the housing at step 217 and exposing the graphite intercalation compound contained in the removable vessel to the flame generated from the gas-based flame generation device to generate the expanded graphite at step 219.

The method 200 further includes preparing the graphite intercalation compound using a starting material and an intercalation agent. The starting material comprises natural flake graphite, synthetic graphite, or a combination thereof and the intercalation agent comprises sulphuric acid, nitric acid, phosphoric acid, potassium permanganate, perchloric acid, or combinations thereof.

In step 211, maintaining the humidity level comprises maintaining the humidity level in a range of from 0.1% to 50%. The humidity level can be maintained by heating the production chamber above ambient temperature. By maintaining the humidity levels, the expansion of the graphite intercalation compound increases.

In step 217, generating the flame comprises providing a flow of working gas from the gas source of the heating system to the gas-based flame generation device. The flow of gas (or gas flow) from the gas source to the gas-based flame generation device can be regulated by the first gas regulator and the second gas regulator, as described above. The gas flow is regulated so that the temperature of the flame generated from the gas-based flame generation device is in a range of 1500 degree Celsius to 3500 degree Celsius. The temperature of the flame depends on the working gas and/or the gas flow rate. Accordingly, the temperature of the flame can be adjusted by using a suitable working gas and/or adjusting its flow rate.

In step 219, the graphite intercalation compound is exposed to a flame generated from the gas-based flame generation device at a temperature in a range of from 1500 degree Celsius to 3500 degree Celsius. In an embodiment, exposing the graphite intercalation compound in the removable vessel comprises rotating the removable vessel containing the graphite intercalation compound about a longitudinal axis of the removable vessel using an automated vessel rotator coupled to the holder. The speed of rotation is in the range of 1 RPM to 100 RPM. In an embodiment, exposing the graphite intercalation compound further comprises tilting the retractable tray about a longitudinal axis of the retractable tray. The retractable tray is titled with the help of a flipper. Rotation of the removable vessel and tilting of the retractable tray ensures exposing most of or all the graphite intercalation compound to the flame generated from the gas-based flame generation device and thereby produce high throughput expanded graphite.

The method 200 further comprises allowing an exhaust gas produced during the expansion process to be removed from the production chamber.

Expanded graphite is widely used in the recovery of oil from water because of its excellent absorption capacity and oleophilic nature. Surface functionalized expanded graphite is also widely used for the treatment of wastewater in water treatment plants for the removal of heavy metals & harmful chemicals and it is also used as an excellent air filter material for removing ozone, VOCs, NOx, and SOx gases. Thin sheets of expanded graphite when made are excellent thermally conductive materials and are used widely in heat spreaders and thermal management systems. Expanded graphite is also a great fire-retardant material which finds applications in high temperature and fire resilient working conditions.

The embodiments herein are illustrated by the following examples which are not meant to restrict the scope of the invention in any manner.

### Example 1

According to one embodiment herein, commercially available GIC was heated in a muffle furnace set at a temperature of 1000° C.-1500° C. for a period of 5-10 minutes. The GIC was expanded along the c-axis to form worm-like structures of expanded graphite. This process of expansion yielded a volume expansion ratio of 50-100 times. 1 gm of GIC was used to produce expanded graphite with a bulk density of 0.64 gm/cm³.

### Example 2

According to one embodiment herein, an intercalated graphite compound was used in the system mentioned in this disclosure. 50 grams of GIC were placed in a ceramic pot and moved inside the chamber with the help of an automated conveyor system. The pots were aligned under the flame channels to expose the GIC to direct heat for the expansion process. The humidity of the chamber was controlled at a range of 0.1%-10%. The flame was set at a flow rate of 100 mL/hour to 150 mL/hour. The fuel or working gas used in this example was from one of the gases mentioned above. For expansion of the GIC, the flame was set at a temperature between 2000° C.-3500° C. The expansion process was completed in 15 seconds and the yield of expansion was 98% wt/wt. The ratio of volume expansion was 300-800 times. The bulk density of GIC was gm/cm³ and the bulk density of expanded graphite after the expansion process was 0.00166 gm/cm³. The surface area of the expanded graphite is 126 m²/g which was measured by BET. The pore size of the expanded graphite was 18.5 nm and pore volume was 0.03057 cc/gm. The resulting expanded graphite had a C/O ratio of 11.9.

### Example 3

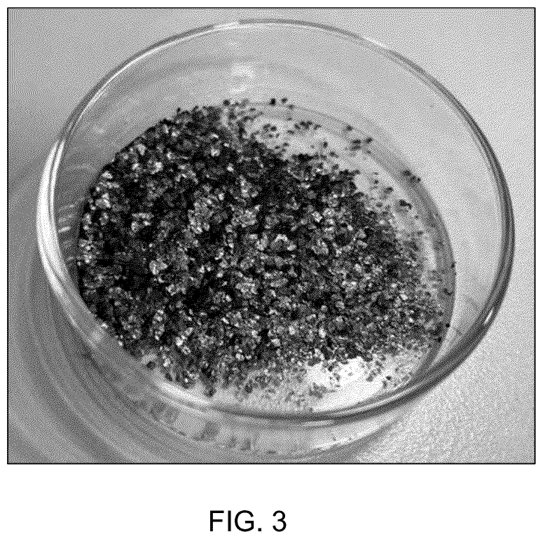

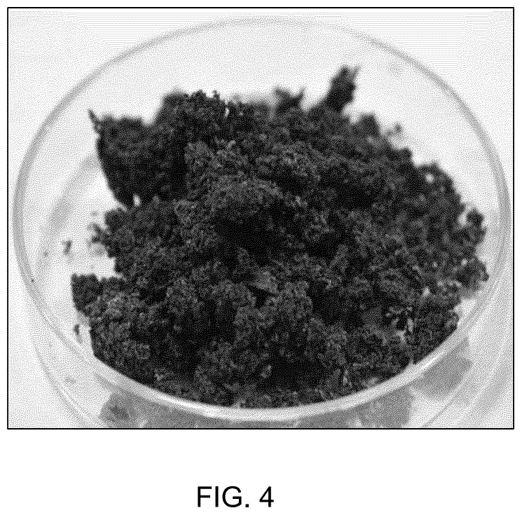

According to one embodiment herein, a proprietary intercalated graphite compound was used in the system. FIG. 3 depicts a photograph illustrating a non-expanded form of GIC before processing in the low-cost production system, as disclosed herein. 50 grams of GIC was placed in a ceramic pot and moved inside the chamber with the help of an automated conveyor system. The pot was aligned under the flame channel to expose the GIC to direct flame generated from the gas-based flame generation device. The humidity of the chamber was controlled at a range 10%-15%. The gas flow to the gas-based flame generation device was set at a flow rate of 150 mL/hour to 300 mL/hour. The fuel (i.e., working gas) used in this example was from one of the gases mentioned above. For the expansion of the GIC, the flame temperature was maintained between 1000° C.-1500° C. The expansion process was completed in 20 seconds and the yield of expansion was 95% wt/wt. The ratio of volume expansion was 200-500 times. The bulk density of GIC was 0.64 gm/cm³ and the bulk density of expanded graphite after the expansion process in this system was 0.002 gm/cm³. The surface area of the expanded graphite is 110 m²/g which was measured by BET. The pore size of the expanded graphite was 23.5 nm and pore volume was 0.030 cc/gm. The resulting expanded graphite had a C/O ratio of 10.2. FIG. 4 illustrates a photograph of expanded graphite.

### Example 4

According to one embodiment herein, a proprietary intercalated graphite compound was used in the system mentioned in this invention. 50 grams of GIC was placed in a ceramic pot and moved inside the chamber with the help of an automated conveyor system. The pot was aligned under the flame to expose the GIC to direct heat for the expansion process. The humidity of the chamber was controlled at a range 15%-20%. The gas flow to generate the flame was set at a flow rate of 300 mL/hour to 1000 mL/hour. The working gas used in this example was from one of the gases mentioned above. For the expansion of the GIC, a temperature of the flame was maintained between 1500° C.-2000° C. The expansion process was completed in 20 seconds and the yield of expansion was 96% wt/wt. The ratio of volume expansion was 250-550 times. The bulk density of GICs was 0.64 gm/cm³ and the bulk density of expanded graphite after the expansion process in this system was 0.0018 gm/cm³. The surface area of the expanded graphite is 113 m2/g which was measured by BET. The pore size of the expanded graphite was 21.5 nm and pore volume was cc/gm. The resulting expanded graphite had a C/O ratio of 10.8.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however, that it is not intended to limit the disclosure to the forms disclosed, but on the contrary, the disclosure is to cover all modifications, equivalents, and alternatives falling within the scope of the disclosure.

The embodiments herein disclose a system and method for low-cost production of expanded graphite. In addition, the embodiments herein also provide a low-cost, highly scalable system, and automated system design for the expansion of intercalated graphite compounds. The technical advantages envisaged by the embodiment herein include a system design that eliminates the use of high energy-consuming production methods and provides a very simple gas-based heating approach for the expansion of GICs. The other technical advantages include providing a unique approach of an automated system for the synthesis and production of expanded graphite with the help of a gas-based heating system (i.e., the gas-based flame generation device coupled to the heating system, as disclosed herein) in the ambient atmosphere. The gas-based heating system utilizes inexpensive gas resources and is a simple and easy-to-use system. Also, the production system and method of expanded graphite disclosed herein do not involve a labor-intensive system as compared to highly labor-intensive systems such as microwave-based systems known in the art. Hence, the system of the embodiments herein eliminates the method of microwave heating or extremely high temperature plasma heat for expansion of intercalated graphite thereby reducing production cost. A single point of energy source is used for rapid expansion of intercalated graphite.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein are for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

I/We claim:

1. A system (100) for production of expanded graphite, comprising:
a housing (101) defining a production chamber (101a) having an open side (101b), the housing (101) comprises:
opening (102) in a wall of the housing (101) to removably receive a gas-based flame generation device (108) into the production chamber (101a);
an exhaust outlet (103) to remove exhaust gases from the production chamber (101a); and
a retractable tray (104) movable into the production chamber (101a) through the open side (101b); and wherein the retractable tray (104) comprises a holder (105) that holds a removable vessel (106), wherein the removable vessel (106) contains a graphite intercalation compound to produce the expanded graphite on heating the graphite intercalation compound using the gas-based flame generation device (108).

2. The system (100) according to claim 1, wherein the gas-based flame generation device (108) is coupled to a heating system.

3. The system (100) according to claim 2, wherein the heating system comprises a gas source (115), a first gas regulator (114) coupled to the gas source (115) and a second gas regulator (109) coupled to the gas-based flame generation device (108).

4. The system (100) according to claim 3, wherein the gas source (115) comprises a working gas selected from a group consisting of natural gas, petroleum gas or a combination thereof.

5. The system (100) according to claim 4, wherein the working gas comprises Methane, Ethane, Propane, Butane, Acetylene, Butylene, Ethylene, Hydrogen, Propylene, Coal gas, blue water gas, Oxy-acetylene or CNG or a combination thereof.

6. The system (100) according to claim 1, wherein the retractable tray (104) comprises an automated vessel rotator coupled to the holder (105) to rotate the removable vessel (106) about a longitudinal axis of the vessel.

7. The system (100) according to claim 6, wherein the automated vessel rotator is configured to rotate the removable vessel (106) in a range of 1 RPM to 100 RPM.

8. The system (100) according to claim 1, wherein a flipper (119) is coupled to the retractable tray (106) to rotate the tray about a longitudinal axis of the retractable tray (106).

9. The system (100) according to claim 1, wherein the production chamber (101a) is maintained at a humidity level of 0.1% to 50%.

10. The system (100) according to claim 1, wherein the gas-based flame generation device (108) is configured to generate a flame at a temperature in a range of from 1500 degree Celsius to 3500 degree Celsius.

11. The system (100) according to claim 1, further comprises a removable storage tank (107) installed below the production chamber (101a) to collect the expanded graphite from the removable vessel (106) held on the retractable tray (104).

12. A method (200) for producing expanded graphite, comprising the steps of:
maintaining a humidity level in a production chamber defined by a housing (211);
disposing an amount of a graphite intercalation compound in a removable vessel hold on to a retractable tray by a holder, wherein the retractable tray is movable into the production chamber (213);
moving the retractable tray with the removable vessel containing the graphite intercalation compound into the production chamber (215);
generating a flame from a gas-based flame generation device that is received in the production chamber through an opening in a wall of the housing (217); and
exposing the graphite intercalation compound contained in the removable vessel to the flame generated from the gas-based flame generation device to generate the expanded graphite (219).

13. The method (200) according to claim 12, wherein the humidity level in the production chamber is maintained in a range of from 0.1% to 50%.

14. The method (200) according to claim 12, wherein the step of exposing the graphite intercalation compound comprises rotating the removable vessel containing the graphite intercalation compound about a longitudinal axis of the removable vessel using an automated vessel rotator coupled to the holder.

15. The method (200) according to claim 12, wherein the step of exposing the graphite intercalation compound further comprises tilting the retractable tray about a longitudinal axis of the retractable tray.

16. The method (200) according to claim 12, wherein the step of exposing the graphite intercalation compound comprises maintaining the flame generated from the gas-based flame generation device at a temperature in a range of from 1500 degree Celsius to 3500 degree Celsius.

17. The method (200) according to claim 12, wherein the step of generating the flame comprises providing a flow of working gas from a gas source of a heating system to the gas-based flame generation device, wherein the heating system is coupled to the gas-based flame generation device.

18. The method (200) according to claim 12, wherein the step of generating the flame comprises regulating the flow of gas from the gas source to the gas-based flame generation device.

19. The method (200) according to claim 19, wherein the working gas comprises natural gas or petroleum gas.

20. The method (200) according to claim 12, further comprises allowing an exhaust gas to be removed from the production chamber.
